(19) United States
(12) Patent Application Publication
(10) Pub. No.: US 2009/0179541 A1
(43) Pub. Date: Jul. 16, 2009

(54) VACUUM INSULATION PANEL WITH SMOOTH SURFACE METHOD FOR MAKING AND APPLICATIONS OF SAME

(75) Inventors: Douglas M. Smith, Albuquerque, NM (US); Stephen Wallace, Albuquerque, NM (US)

Correspondence Address: MARSH, FISCHMANN & BREYFOGLE LLP, 8055 East Tufts Avenue, Suite 450, Denver, CO, 80237, US

(73) Assignee: NANOPORE, INC., Albuquerque, NM (US)

(21) Appl. No.: 12/332,596

(22) Filed: Dec. 11, 2008

Related U.S. Application Data
(60) Provisional application No. 61/012,996, filed on Dec. 12, 2007.

(51) Int. Cl. F25D 23/06; B32B 1/06; B32B 37/00

(52) U.S. Cl. 312/406; 428/69; 156/145

(57) ABSTRACT

Vacuum insulation panels and methods for making vacuum insulation panels. The panels include first and second spaced-apart sidewalls, where at least one of the sidewalls has a very smooth surface. The panels are particularly useful as insulation in applications where a smooth and aesthetically acceptable surface is required, such as in a refrigeration appliance. A method for making a vacuum insulation panel can include placing an insulative core material and a liner within a barrier envelope defining an enclosure, evacuating the enclosure, and sealing the envelope to form the vacuum insulation panel.

### CROSS-REFERENCE TO RELATED APPLICATIONS

This application claims priority to U.S. Provisional Patent Application Ser. No. 61/012,996 entitled “VACUUM INSULATION PANEL WITH SMOOTH SURFACE AND METHOD FOR MAKING SAME”, filed Dec. 12, 2007, the disclosure of which is incorporated herein by reference in its entirety.

### BACKGROUND OF THE INVENTION

1. Field of the Invention

The present invention relates to the field of vacuum insulation panels (VIPs) and methods for making vacuum insulation panels. The panels can be used in a variety of applications, such as to insulate refrigeration appliances.

2. Description of Related Art

Thermal insulation is a porous material with an inherently low thermal conductivity, which serves to protect the system of interest from heat flow in or out to its surroundings. The use of thermal insulation is prevalent in society ranging from use in domestic refrigerators for reduced energy consumption or additional internal volume, in shipping containers containing ice or dry ice used for drugs or food to extend the lifetime of the shipment, and in the tiles on the space shuttle to protect the shuttle from the heat of reentry into the atmosphere. Most thermal insulation products used today are either fibrous materials, such as fiberglass, mineral wool and asbestos, or polymer foams, such as expanded polystyrene, polyurethane, foamed polyethylene and foamed polypropylene. Use of fibrous materials may be undesirable in many instances due to problems related to health and safety. Use of polymer foams may be undesirable due to their flammability, recyclability and release of environmentally unfriendly gases, such as fluorocarbons or hydrocarbons. In addition, the thermal performance of both fibrous materials and polymer foam materials are on the same order as or greater than stagnant air (e.g., about 0.026 W/mK at ambient temperature).

Because of increased concern with respect to energy efficiency and the environment, there has been much interest in the development of new classes of thermal insulation that have a thermal conductivity much less than that of air, such as aerogels, inert gas-filled panels and vacuum insulation panels.

For thermal insulation, a key measure of performance is the thermal conductivity of the material. The lower the thermal conductivity, the lower the heat flow (energy) at a given temperature difference through the insulation. In the absence of convection, heat transfer in insulation occurs due to the sum of three components: solid phase conduction, gas phase conduction and radiation. Solid phase conduction may be minimized by using a low-density material (e.g., a material comprising a high volume fraction of pores). Most insulation is between 80% and 98% porous. It is also advantageous to use a solid material that has a low inherent thermal conductivity (e.g., plastics and some ceramics/glasses are better than metals).

With control of radiation, suppression of free convection, use of low thermal conductivity materials and a highly porous solid matrix, the thermal conductivity of the insulation approaches that of the gas contained within the pores of the insulation. There are at least two methods of lowering gas phase conduction in insulation. The first is to trap gases in the pores, where the gases have a lower thermal conductivity than that of air, such as argon, carbon dioxide, xenon and krypton. Depending upon the gas employed, the thermal conductivity of insulation filled with an inert gas can range from 0.009 to 0.018 W/mK. However, the insulation must be packaged such that the gas does not leak from the pores and also so that atmospheric gases (e.g., nitrogen, oxygen) do not penetrate the insulation.

The second method for controlling or lowering gas phase conduction is to employ the Knudsen effect. Generally, gases transfer heat when gas molecules collide with other gas molecules. The mean free path of a particular gas is the average distance between collisions for the molecules of the gas. The Knudsen effect occurs when a gas is trapped within insulation whose pore size is approximately equal to or smaller than the mean free path of the gas molecules. When the mean free path of the gas approaches the pore size of the insulation, the gas phase conductivity is dramatically reduced. When the mean free path is much larger than the pore size, the gas phase conductivity approaches zero and the total effective thermal conductivity is the sum of only radiation and solid phase conduction. The mean free path of air is approximately 60 nanometers at ambient temperature and pressure. In comparison, the pore/cell size of polymer foams and fibrous materials is typically greater than 10 microns, and the Knudsen effect cannot occur if such polymer foams and fibrous materials are used with air at or near ambient temperature and pressure.

There are at least two approaches that can employ the Knudsen effect to lower gas phase conduction. A first approach is to encapsulate the insulation within a barrier material and partially evacuate the gas in the insulation. This increases the mean free path of the gas by lowering the gas density, which lowers gas phase conduction. Materials employing such gas evacuation techniques can achieve a thermal conductivity of less than 0.002 W/mK at ambient temperatures, which is an order of magnitude improvement over conventional insulation.

The advantages of utilizing a vacuum with an insulative material have been known for many years and are the basis of vacuum Dewars that are used with cryogenic liquids and for storing hot or cold beverages or other products. For example, U.S. Pat. No. 1,071,817 by Stanley discloses a vacuum bottle or Dewar, where a jar is sealed inside another jar with a deep vacuum maintained in the annular space with the two jars being joined at the jar mouth. Such an approach minimizes joining and thermal bridging problems, but most insulation applications require many different shapes that cannot be met by a Dewar.

Another approach is to encapsulate an insulative core material having very small pores and low density within a barrier material. One such class of core materials is nanoporous silica, also known as silica aerogels, which generally have small pores (e.g., <100 nm), a low density and exhibit a total thermal conductivity at ambient pressure that is lower than that of the gas contained within the pores. It is known to use nanoporous silica in conjunction with a vacuum to create a vacuum insulation product. For example, U.S. Pat. No. 4,159,359 by Pelloux-Gervais discloses the use of compacted silica powders, such as precipitated, fumed, pyrogenic, or aerogels, contained in plastic barriers, which are subsequently evacuated. In addition to silica-based vacuum insulation panels, other approaches include using compressed fiberglass, perlite, and open-cell foams as the core material. These materials can offer similar performance to silica-based panels but must be evacuated and maintained at one hundred times deeper vacuum to maintain their thermal performance.

### SUMMARY OF THE INVENTION

The production method for vacuum insulation panels (VIPs) typically causes the VIPs to exhibit a very rough outer surface on the sidewalls. It has been found that this rough outer surface results from slight shrinkage of the core material during evacuation and the fact that the barrier envelope must be slightly larger than the core so that the core can be inserted into the envelope during manufacture. This rough outer surface can inhibit the use of the VIPs in otherwise desirable applications.

To give the VIP a more uniform appearance, a series of grooves or a dimpled texture can be introduced into the panels. However, for some important VIP applications such as domestic and commercial refrigeration equipment, it is undesirable to have such a surface texture. In such equipment, the VIP can be affixed to the inside of the metal cabinet and be subsequently encapsulated by polyurethane foam, which provides additional thermal protection and supports the inner plastic liner of the refrigerator. The polyurethane foam exerts outward pressure on the VIP, which is disposed between the foam and the outer metal skin. As refrigeration production technology has improved, the thickness of the outer metal cabinet has decreased, and often is now less than 1 mm. Due to the outward pressure exerted on the VIP, surface defects and surface texture on the VIP sidewall can show through such a thin outer skin, forming an aesthetically undesirable appearance.

It is therefore an objective to provide a vacuum insulation panel including at least one sidewall that is substantially smooth, and in particular is more uniformally smooth than conventional panels, including those that have a dimpled texture.

It is another objective to provide a vacuum insulation panel that can be used to insulate refrigeration equipment without forming aesthetically undesirable surface defects in the outer cabinet of the equipment.

It is another objected to provide a method for the manufacture of a vacuum insulation panel that includes at least one sidewall that is substantially smooth.

It is another objective to provide a refrigeration appliance that is insulated using a vacuum insulation panel where the refrigeration appliance has an aesthetically acceptable appearance, particularly a smooth outer surface.

According to one embodiment, a vacuum insulation panel is provided where the vacuum insulation panel includes spaced apart first and second sidewalls, where the first sidewall is substantially smoother than the second sidewall.

According to another embodiment, a vacuum insulation panel is provided that includes an insulative core material and a gas impermeable barrier envelope defining an enclosure and surrounding the core material. The barrier envelope can include a heat seal layer, where the heat seal layer is sealed along a perimeter of the envelope to seal the core material within the enclosure and form a vacuum insulation panel having spaced apart first and second sidewalls. A liner can be disposed between the core material and the barrier envelope beneath at least a portion of one of the sidewalls.

Unexpectedly, it has been found that by placing a relatively thin liner between the insulative core material and the barrier envelope, a vacuum insulation panel with an extremely smooth outer surface can be produced. This is despite the fact that the panel can have a thickness of, for example, from about 10 mm to 50 mm.

According to one aspect, the enclosure can be evacuated to a pressure of not greater than about 100 millibars, such as not greater than about 10 millibars. According to another aspect, the insulative core material can include an insulative powder. According to yet another aspect, the insulative material can include a metal oxide, such as silica.

The barrier envelope can be substantially gas impermeable and can comprise a metallized film, such as a metallized polyethylene terephthalate (PET) film. The barrier envelope can also include various polymeric layers including an oxygen barrier (e.g., containing cross-linked polyvinyl alcohol (“PVOH”)) and/or a moisture barrier (e.g., a metallized polymeric composite) bonded thereto or combined therewith. The heat seal layer can be a thermoplastic to facilitate heat-sealing of the enclosure after evacuation. The liner can be a plastic film and the plastic film can comprise a plastic material that is different than the heat seal layer. The liner can also be thicker than the heat seal layer. For example, the liner can have a thickness of at least about 0.025 mm and not greater than about 1 mm, and more preferably at least about 0.05 mm and not greater than about 0.5 mm. In one aspect, the liner can be a film of material such as polystyrene or polypropylene.

As is noted above, the portion of the first sidewall beneath which the liner is disposed can be substantially smoother than the second sidewall. That is, the first sidewall can have a reduced roughness.

The liner can be disposed beneath only a portion of the first sidewall, and in one aspect is disposed beneath the entire first sidewall so that substantially the entire first sidewall is smooth. A liner can also be disposed beneath a portion of the second sidewall, or beneath the entire second sidewall.

According to another embodiment, a method for making a vacuum insulation panel is provided. The method can include placing an insulative core material within an enclosure defined by a barrier envelope. A liner can be disposed between the core material and at least a portion of the barrier envelope. The enclosure can then be evacuated and sealed to form a vacuum insulation panel having spaced apart first and second sidewalls, where at least one of the sidewalls has a reduced roughness.

According to another embodiment, a refrigeration appliance is provided. The refrigeration appliance can be in the form of a refrigerator, freezer, and the like, and can include an outer metal cabinet having an interior surface and an exterior surface. A liner can be disposed inside the cabinet with an insulative layer, such as blown foam, between the outer metal cabinet and the liner. At least one vacuum insulation panel is provided having opposed first and second spaced-apart sidewalls, wherein the first sidewall is disposed against the interior surface of the outer metal cabinet, wherein the first sidewall of the vacuum insulation panel is smoother than the second sidewall.

Accordingly, the exterior surface of the metal cabinet retains an aesthetically acceptable smooth appearance due to the smooth sidewall surface on the vacuum insulation panel. The second sidewall of the vacuum insulation panel, which is rougher than the first sidewall, advantageously provides strong bonding to the foam insulation due to the uneven texture. The metal cabinet can be very thin, such as not greater than about 1 mm in thickness.

### DESCRIPTION OF THE DRAWINGS

FIG. 1 illustrates a schematic cross-section of a refrigeration appliance that includes vacuum insulation panels.

FIG. 2a is a photograph of a surface of a conventional vacuum insulation panel produced without surface texture.

FIG. 2b is a photograph of a surface of a conventional vacuum insulation panel produced without surface texture.

FIG. 2c is a photograph of a surface of a conventional vacuum insulation panel produced using surface dimpling.

FIG. 3 illustrates a schematic cross-section of a vacuum insulation panel containing a liner that is adapted to reduce surface roughness.

FIG. 4 is a photograph of a smooth surface of a vacuum insulation panel.

FIG. 5 is a flowsheet illustrating a method of producing a vacuum insulation panel.

### DESCRIPTION OF THE INVENTION

A vacuum insulation panel having a smooth sidewall, a method for producing such a vacuum insulation panel and appliances incorporating such panels, will now be described with reference to the attached figures.

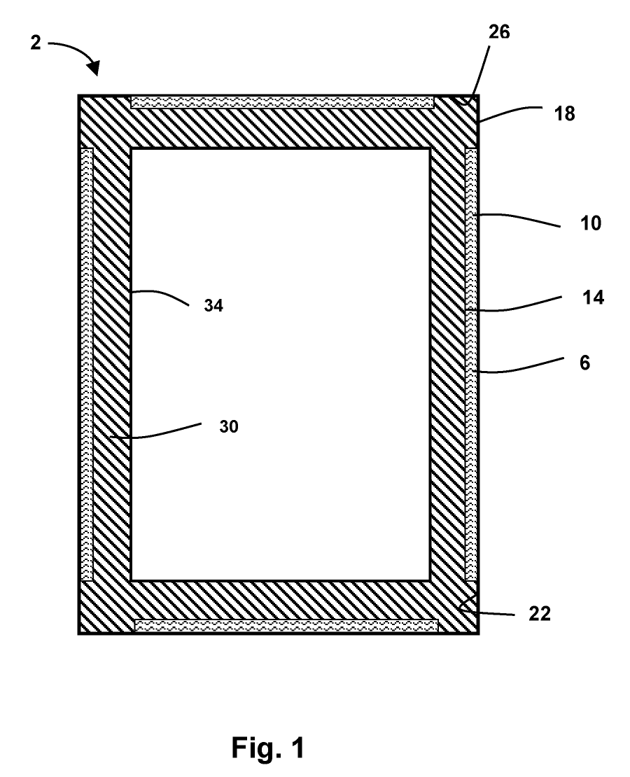

FIG. 1 illustrates a cross-sectional schematic view of a conventional insulated refrigeration appliance 2 including at least one vacuum insulation panel 6 that comprises an insulative core material 10 and a barrier envelope 14 surrounding the core material 10. One example of such a refrigeration appliance is illustrated in U.S. Pat. No. 5,082,335 by Cur et al., which is incorporated herein by reference in its entirety.

The refrigeration appliance 2 includes an outer metal cabinet 18 (i.e., metal skin) defining an exterior of the appliance 2. During manufacture, one or more vacuum insulation panels 6 can be disposed against an interior surface such as side surface 22 and/or top surface 26 of the metal cabinet 18. For example, each vacuum insulation panel 6 can be adhered to the metal cabinet 18 such as through the use of double-sided tape or pressure sensitive adhesives, a hot-melt adhesive, a reactive adhesive, UV and light curing adhesives, and the like.

Insulative foam 30 such as a polyurethane foam is typically blown into a space between the metal cabinet 18 and an inner plastic liner 34. The polyurethane foam places significant outward pressure on each vacuum insulation panel 6 pressing it outwardly against the metal cabinet 18. Because the metal cabinet 18 can be quite thin, such as not greater than about 1 mm in thickness, rough texture on the sidewall of the vacuum insulation panel 6 that is against the cabinet 18 can result in undesirable surface defects on the outer surface of the metal cabinet 18.

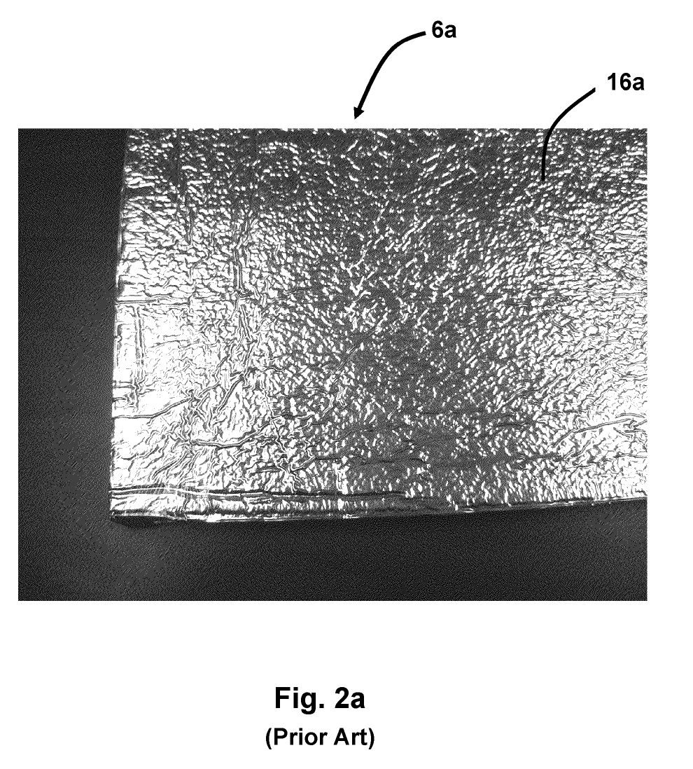

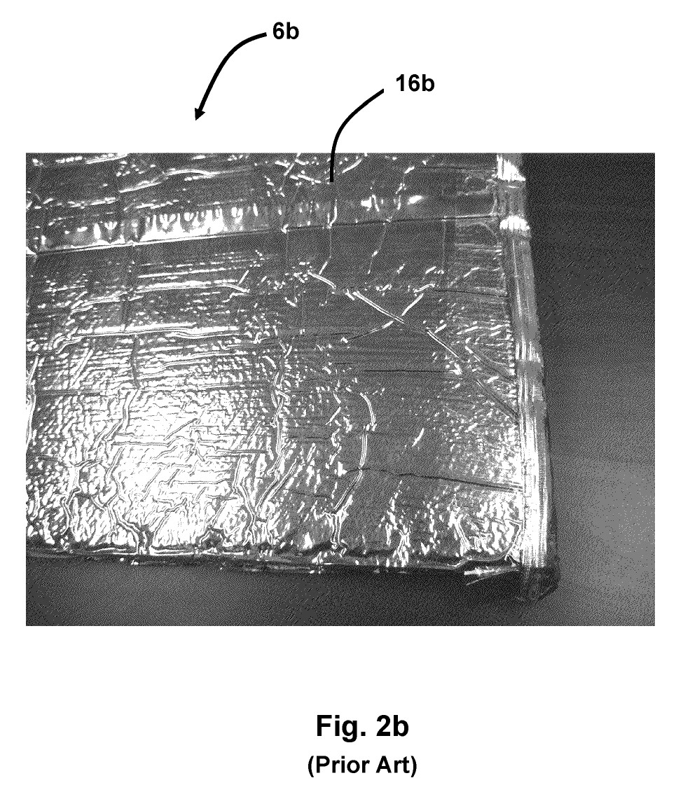

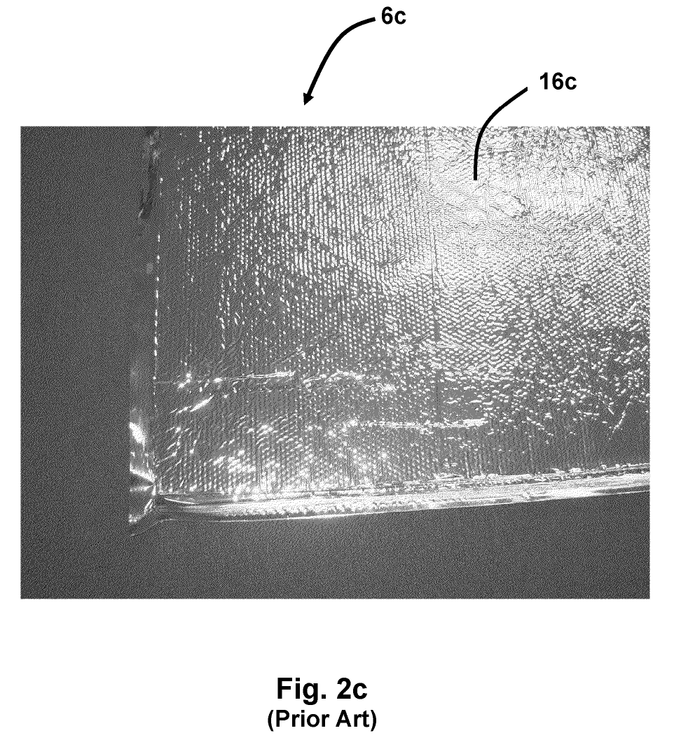

FIGS. 2a-2c illustrate the sidewalls 16a, 16b and 16c of various conventional vacuum insulation panels 6a, 6b, and 6c. For instance, FIGS. 2a-2b illustrate examples of vacuum insulation panels 6a and 6b without surface texturing. As previously discussed, the rough or wrinkled appearance of the surface of the sidewalls results from the shrinkage of the insulative core material during evacuation of the barrier envelope and from the fact that the barrier envelope is typically slightly larger than the insulative core material to allow insertion of the insulative core material into the barrier envelope during manufacture. However, a rough or wrinkled surface of the vacuum insulation panel could result from other causes.

FIG. 2c illustrates a more uniform appearance of a sidewall 16c of a conventional vacuum insulation panel 6c by providing localized surface texturing such as dimpling. Other types of localized surface texturing can be used. However, the surface is still too rough to be used in many applications.

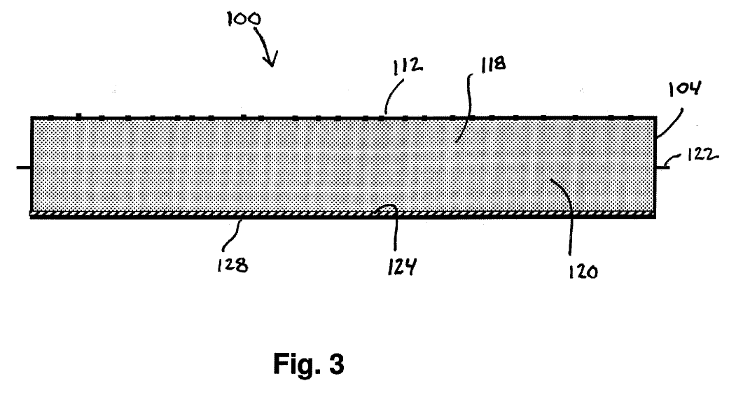

A cross-sectional view of an exemplary vacuum insulation panel 100 having a smooth surface is illustrated in FIG. 3. The vacuum insulation panel 100 includes an insulative core material 120. A substantially gas permeable barrier envelope 104 is sealed along a perimeter 122 of the envelope to form a substantially gas-impermeable enclosure 118. The insulative core material 120 is disposed within the enclosure 118. In the embodiment illustrated in FIG. 3, the first sidewall 128 is smooth, and in particular, is smoother than the second sidewall 112.

One method to form such a smooth sidewall is to place an inner liner 124 between the insulative core material 120 and the barrier envelope 104. It has unexpectedly been found that the presence of an inner liner, even a relatively thin liner, between the insulative core material 120 and the barrier envelope 104 substantially prevents localized deformation (e.g., wrinkling) of both the core and the barrier envelope that is commonly observed in conventional vacuum panel production.

After the insulative core material 120 and an inner liner 124 have been placed or otherwise disposed within the barrier envelope 104, the barrier envelope 104 can be evacuated to a pressure that is much less than atmospheric pressure and sealed along its perimeter 122. Preferably, the internal pressure within the enclosure 118 is not greater than about 100 millibars, and more preferably is not greater than about 10 millibars and even more preferably is not greater than about 5 millibars. Such a reduced internal pressure advantageously facilitates the Knudsen effect by increasing the mean free path of the air or other gas within the enclosure 118 relative to the pore size of the insulative core material 120. In one embodiment, the vacuum insulation panel 100 can have a thickness, for example, of at least about 5 mm and not greater than about 75 mm, such as at least about 10 mm and not greater than about 50 mm. Other sizes and configurations of a vacuum insulation are possible.

Thus, a vacuum insulation panel 100 can be produced having an extremely smooth outer sidewall 128. The smooth sidewall 128 allows the vacuum insulation panel 100 to be used in appliances having extremely thin metal cabinets. Stated another way, the sidewall 128 can have a very low surface roughness, and in one embodiment the surface roughness of sidewall 128 is less than the surface roughness of sidewall 112. Surface roughness measurements may be determined and quantified using a profilometer or other appropriate device.

When the vacuum insulation panel 100 having a smooth sidewall 128 is used with the refrigeration appliance such as that illustrated in of FIG. 1, the smooth sidewall 128 allows the exterior surface of the metal cabinet to maintain a smooth and aesthetically acceptable appearance.

Further, the second sidewall 112 of the vacuum insulation panel 100 that is opposite the first sidewall 128 can have a rough surface, such as would be found in a conventional vacuum insulation panel. When the panel is placed in a refrigeration appliance with the smoother sidewall 128 against the metal skin of the appliance, this rough surface advantageously allows the insulative foam, e.g., blown insulative foam to more readily adhere or bond to the vacuum insulation panel 100. Thus, for this and similar applications, it has been found desirable to fabricate the panel 100 with only one smooth sidewall.

It will be appreciated that many feature refinements of the vacuum insulation panel 100 exist. While the vacuum insulation panel 100 is illustrated as only having one smooth sidewall, an inner liner 124 could alternatively or additionally be disposed between the core material 120 and the barrier envelope 104 beneath the second sidewall 112. Such an embodiment could be advantageous when each of the first and second sidewalls 128, 112 of the vacuum insulation panel 100 are to contact another thin surface of material, or when a more uniform overall appearance of the vacuum insulation panel 100 is otherwise desired. Additionally, while the vacuum insulation panel 100 has been shown as being generally flat and rectangularly shaped, the vacuum insulation panel 100 could alternatively be in the form of other shapes (e.g. circular, polygonal, etc.) or thicknesses to suit various applications.

In one embodiment, the inner liner 124 is a plastic film liner. For example, the liner 124 can comprise polystyrene, such as high impact polystyrene (HIPS) or polypropylene. In other embodiments, the liner 124 may comprise various types of other plastic material such as polyethylene or polyvinyl chloride. The thickness of the inner liner can be relatively thin. For example, the liner 124 can have a thickness of not greater than about 1.0 mm, and even not greater than about 0.5 mm. Good results can be obtained when the liner 124 is at least about 0.05 mm in thickness. Where the barrier envelope 104 includes a heat seal layer (discussed below), the liner 124 is typically thicker than the heat seal layer. In one embodiment, the liner is also stiffer than the heat seal layer, i.e., the liner has a higher modulus of elasticity than the heat seal layer.

The insulative core material 120 can be any material that has a relatively low thermal conductivity. Examples include thermally insulative fibers such as fiberglass, open celled foams such as polyurethane or polystyrene foams, insulative monolithic materials or insulative powder. In one embodiment, the insulative core material 120 includes pores sized to facilitate the Knudsen effect, such as pores having an average pore size of not greater than about 100 nm. In other embodiments, the pores of the insulative core material 120 are at least smaller than the mean free path of air or another gas contained within the barrier envelope 104. The insulative core material 120 should also have a relatively low inherent solid-phase thermal conductivity, and in one embodiment the insulative core material 120 has a solid-phase thermal conductivity of not greater than about 0.01 W/mK, and more preferably not greater than about 0.005 W/mK. Preferably, the insulative core material 120 is also relatively inexpensive and is lightweight, such as an insulative material having a bulk density in the final vacuum insulation product of not greater than about 0.50 g/cm³ and more preferably not greater than about 0.25 g/cm³.

In one embodiment, the insulative core material 120 is in the form of an insulative powder. Such, insulative powders can include, but are not limited to, metal oxides, particularly silica (SiO₂), aluminosilicates, siliceous minerals such as perlite, and alumina (Al₂O₂), particularly fumed alumina. One preferred insulative powder is a nanoporous metal oxide and particularly silica, such as fumed silica or a silica aerogel. Such materials are available from, for example, DeGussa GmBH, Dusseldorf, Germany under the trade name AEROSIL.

The insulative core material 120 can also include, for example, fibrous material that is adapted to enhance the structural integrity of the vacuum insulation panel. Preferred materials include those that are lightweight, inexpensive and structurally sound, such as polyethylene fibers, polyester fibers and other polymer fibers. Carbon fibers, glass fibers and metal fibers can also be used. The insulative core material 120 can also include a scattering material that is adapted to scatter infrared radiation. The scattering material can advantageously lower the thermal conductivity of the vacuum insulation panel 100 by reducing radiation effects from infrared radiation. Suitable scattering materials include, for example, titania (TiO₂).

The barrier envelope 104 can be made of a material that is substantially impermeable to atmospheric gases (e.g., nitrogen and oxygen) and can be, for example, a metallized plastic, such as metallized polyethylene terephthalate (PET), a bi-axially oriented polypropylene (BOPP) film, and the like. The barrier envelope 104 can also be constructed of various types of plastic laminates. For example, the barrier envelope can include alternating metal layers and plastic layers. Further, metal oxide layers can be used in place of one or more of the metallic layers to reduce thermal bridging on the outside of the panel by reducing the thermal conductivity of the envelope 104. The barrier envelope 104 can also include a thermoplastic or other type of heat seal layer on the internal surface of the envelope 104 to facilitate heat-sealing of the barrier envelope 104 after evacuation.

It is often desirable that the barrier envelope be relatively thin. In one embodiment, the barrier envelope has a thickness of not greater than about 200 μm, such as not greater than about 120 μm. A reduced thickness can reduce thermal bridging, and enhance the performance of the vacuum insulation panel. The envelope should be sufficiently thick to maintain structural integrity and maintain a reduced pressure within the envelope. In one embodiment, the envelope can be at least about 60 μm in thickness. As is noted above, the barrier envelope can be multilayered and typically also includes a heat seal layer. In one embodiment, the heat seal layer on the interior of the envelope is not greater than about 50 μm in thickness, such as from about 10 μm to 50 μm in thickness.

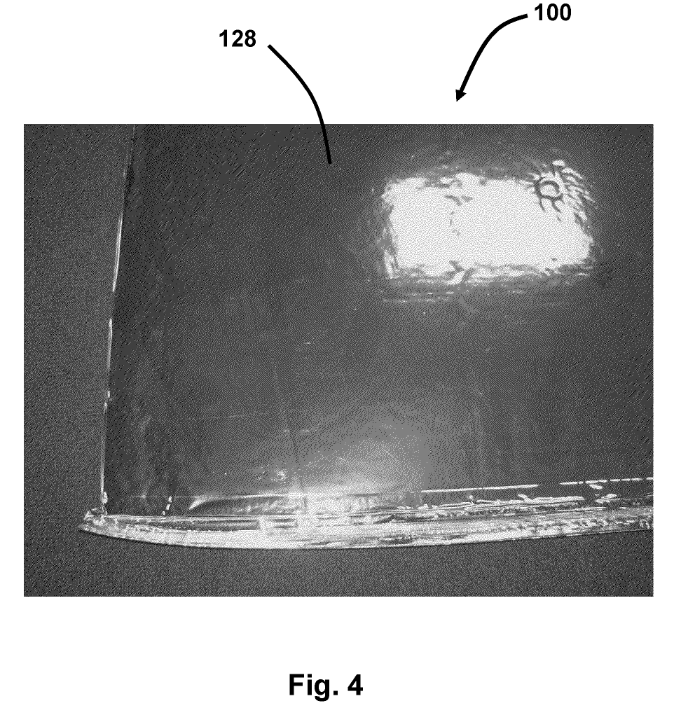

A photograph of a vacuum insulation panel 100 having a smooth sidewall 128 is illustrated in FIG. 4. As compared to the prior art panels illustrated in FIGS. 2a-2c, the sidewall 128 has a significantly reduced roughness and therefore can be used in a variety of applications that can benefit from the use of vacuum insulation panels.

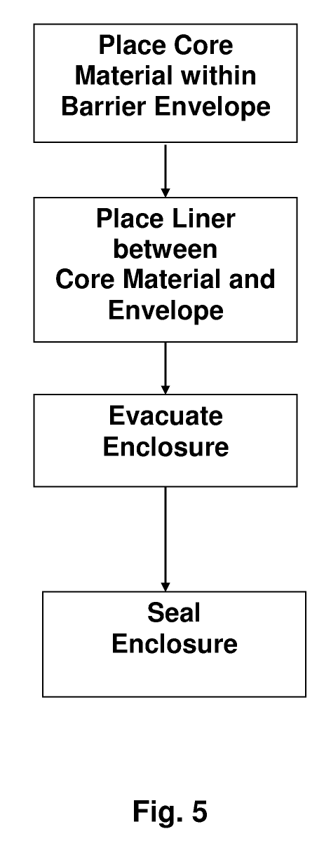

A vacuum insulation panel having a smooth outer surface can be manufactured by a variety of methods. Referring to FIG. 5, the method can include the step of placing an insulative core material within an enclosure defined by a barrier envelope. A liner, such as a plastic film liner, can be placed within the substantially gas impermeable barrier envelope between the core material and the barrier envelope. The envelope can then be evacuated to reduce the pressure within the enclosure and the envelope can be sealed along a perimeter of the envelope to form the vacuum insulation panel.

The sealing steps can be accomplished in any known manner suitable to the type of enclosure employed. For example, heat sealing can be used for plastic laminate barrier materials and welding can be used for metal barrier materials.

The step of evacuating the enclosure reduces the pressure within the enclosure containing the insulative core material to below atmospheric pressure, such as by using a vacuum pump. In this regard, various known devices can be used to evacuate the enclosure. For example, evacuation units available from MULTIVAC, INC. (Kansas City, Mo., U.S.A.) can be used. Preferably, after the final sealing step, the pressure within the vacuum insulation product is significantly reduced relative to atmospheric pressure. In this regard, the pressure within the product is preferably reduced to not greater than about 100 millibars, more preferably not greater than 10 millibars, and even more preferably not greater than 5 millibars.

It will be appreciated that other methods of producing the vacuum insulation panel are contemplated as being within the scope of this invention. For example, the liner could be formed as an integral layer of the barrier envelope. The insulative core material can then be placed within the envelope, and then the perimeter of the envelope can be sealed to form the insulation panel.

While various embodiments of the present invention have been described in detail, it is apparent that modifications and adaptations of those embodiments will occur to those skilled in the art. However, is to be expressly understood that such modifications and adaptations are within the spirit and scope of the present invention.

What is claimed is:

1. A vacuum insulation panel comprising spaced apart first and second sidewalls, wherein said first sidewall is substantially smoother than said second sidewall.

2. A vacuum insulation panel, comprising:
an insulative core material;
a substantially gas impermeable barrier envelope defining an enclosure and surrounding said core material, said barrier envelope comprising a heat seal layer, said heat seal layer being sealed along a perimeter of said envelope to seal said core material within said enclosure and form a panel having spaced apart first and second sidewalls; and
a liner disposed between said core material and said barrier envelope beneath at least a portion of said first sidewall.

3. A vacuum insulation panel as recited in claim 2, wherein said enclosure is evacuated to a pressure of not greater than about 100 millibars.

4. A vacuum insulation panel as recited in claim 2, wherein said insulative core material comprises an insulative powder.

5. A vacuum insulation panel as recited in claim 2, wherein said insulative material comprises a metal oxide.

6. A vacuum insulation panel as recited in claim 2, wherein said barrier envelope further comprises a metallized film.

7. A vacuum insulation panel as recited in claim 6, wherein said barrier envelope further comprises metallized polyethylene terephthalate (PET).

8. A vacuum insulation panel as recited in claim 2, wherein said heat seal layer comprises a thermoplastic.

9. A vacuum insulation panel as recited in claim 2, wherein said liner comprises a material that is different than said heat seal layer.

10. A vacuum insulation panel as recited in claim 2, wherein said liner comprises a plastic material.

11. A vacuum insulation panel as recited in claim 2, wherein said liner comprises a plastic selected from polypropylene and polystyrene.

12. A vacuum insulation panel as recited in claim 2, wherein said liner has a thickness that is greater than the thickness of said heat seal layer.

13. A vacuum insulation panel as recited in claim 12, wherein said liner has a thickness of at least about 0.05 mm.

14. A vacuum insulation panel as recited in claim 13, wherein said liner has a thickness of not greater than about 0.5 mm

15. A vacuum insulation panel as recited in claim 2, wherein said portion of said first sidewall is smoother than said second sidewall.

16. A vacuum insulation panel as recited in claim 2, further comprising a second liner disposed between said core material and said barrier envelope beneath at least a portion of said second sidewall.

17. A refrigeration appliance comprising a inner plastic liner, an outer metal cabinet and an insulative foam blown in between said inner plastic liner and said outer metal cabinet, and further comprising a vacuum insulation panel as recited in claim 1 disposed between at least a portion of said plastic liner and said metal cabinet, wherein said first sidewall is disposed against said metal cabinet.

18. A method for making a vacuum insulation panel, comprising the steps of:
placing an insulative core material within an enclosure defined by a barrier envelope;
placing a liner between said core material and at least a portion of said barrier envelope;
evacuating said enclosure; and
sealing said enclosure to form a vacuum insulation panel having spaced apart first and second sidewalls.

19. A method as recited in claim 18, wherein said liner comprises a plastic material and has a thickness of at least about 0.05 mm.

20. A method as recited in claim 19, wherein said plastic material is selected from polystyrene or polypropylene.
